(19) United States
(12) Patent Application Publication
(10) Pub. No.: US 2015/0260089 A1
(43) Pub. Date: Sep. 17, 2015

(54) DEVICE FOR COOLING AND PRESSURIZATION

(71) Applicant: Chung-Shan Institute of Science and Technology, Armaments Bureau, M.N.D, Taoyuan County (TW)

(72) Inventors: Dun-Zen Jeng, Taoyuan County (TW); Ming-Chun Hsieh, Taoyuan County (TW); Chih-Chuan Lee, Taoyuan County (TW); Ting-Hua Chieh, Taoyuan County (TW)

(73) Assignee: Chung-Shan Institute of Science and Technology, Armaments Bureau, M.N.D, Taoyuan County (TW)

(21) Appl. No.: 14/213,648

(22) Filed: Mar. 14, 2014

(51) Int. Cl. F02B 53/08; F01P 1/04; F02B 53/06

(52) U.S. Cl. CPC F02B 53/08; F02B 53/06; F01P 1/04

(57) ABSTRACT

A device for cooling and pressurization, which is composed of a charger, an outlet tube couples the mechanical charger, a first valve coupled to the charger outlet tube and a engine intake tube, a second valve coupled to the charger outlet tube and a core cooling tube, and a rotary engine body coupled to the engine intake tube and the core cooling tube. The device of the present invention has functions with cooling and/or pressurization, and manners of the engine intake and core heat dissipation intake can be used in the device to perform the core cooling by the serial, parallel or independent manner.

### BACKGROUND OF THE INVENTION

1. Field of the Invention

The present invention relates to a device for cooling and pressurization, and more particularly, to a device, which allows a booster to achieve dual functions with cooling and pressurization.

2. Description of the Related Art

The performance of the rotary engine is basically determined by its geometry including the air intake/exhaust time sequence arrangement (port site), the ignition timing, the cylinder volume, the air fuel ratio, and the like. Because the rotary engine contains three chambers (the cylinder) and has the property of the small size, the heat dissipation is always an urgent problem in the development. In the past years, the development of the heat dissipation mainly adopts the air cooling on the external. However, as the power required increased, the heat dissipation requirement is also rising, and the existing problems and shortages of the air cooling apparently appear. Thereby, manners of the water cooling and the oil cooling are developed for solving these problems and shortages. Nevertheless, most devices with functions of water cooling or oil cooling still focus on the external cooling. As opposed to the reciprocation engine, the internal of rotary engine also needs a better heat dissipation to reduce the abrasion on the crank shaft by high-temperature deformation and worsen the efficiency. Water or oil cooling, effective on the external cooling, is rarely adopted in the internal of a rotary engine for its sophisticated air passage pulsating flow, and thus air cooling is still widely used.

The rotor core cooling development mainly adopts ram pressure by the carrier velocity with an intake duct to guide the air flow into the core path for the heat dissipation. The mentioned manner is adopted in the rotor core cooling in dealing with high heat load at high rotational speed when outputting higher power. Therefore, it is the main purpose to increase the amount of cooling air at high RPM. As aforementioned, the complicated pulsating (discontinuous) air flow and high passage blockage make the cooling flow less. Though, at high rotational speed, ram pressure may be effective in increasing the cooling flow, at low RPM, the cooling flow is little. The cooling lubricant oil in bearings works on heat dissipation of rotor crank shaft, and that is insufficient. As heat dissipation is concerned, redesign oil/lubrication system is time and cost consuming with its complexity.

For the reason that the conventional method and device could not effectively solve the mentioned problems, a need has arisen to propose a device for cooling and pressurization which applies in the heat dissipation with full range rotational speed.

### SUMMARY OF THE INVENTION

An object of the present invention is to provide a device for cooling and pressurization, and the device can overcome the disadvantages of the conventional technology. For increasing the air charge quantity of the engine combustion, it is the most effective way to adopt the booster in the present invention. At present, the booster (the mechanical booster and turbocharger) is mostly used to enhance the performance. In other word, the air charge quantity increases, so does the heat. Therefore, the heat dissipation needs adjusting. Adopting the mechanical booster on rotary engine core cooling or performance enhancement or both, the air flow rate should be adjustable based on each or both requirements.

The mechanical booster of the present invention has functions with cooling and/or pressurization. The configuration of the engine intake and/or core heat dissipation intake in connection with the booster by serial, parallel, or unique for core cooling can achieve the core cooling in the device of the present invention or satisfy the core cooling requirement when enhancing or maintain the performance requirement by adjusting the flow distribution to core cooling and engine chambers. In comparison with lubrication/oil system redesign, installing a booster, intake tubes and valves on the engine at the present invention with valve control, none of any modification on the engine hardware, is much more effective in cost, maintenance, and assembly.

For achieving the object above, a device for cooling and pressurization is disclosed according to one embodiment of the present invention. The device for cooling and pressurization comprises: a mechanical charger, an outlet device, mounted on the charger for air flow dispensing, wherein the outlet tube is branches into two airways, and one is couple to the engine intake tube; a first valve, for controlling air charge quantity of the engine chamber, wherein one terminal of the first valve is coupled to the charger outlet tube, and another terminal thereof is coupled to the engine intake tube; a second valve, for controlling air charge quantity of a core cooling tube, wherein one terminal of the second valve is coupled to the charger outlet tube, and another terminal thereof is coupled to the cooling tube, for allowing the device for cooling and/or pressurization.

### BRIEF DESCRIPTION OF THE DRAWINGS

The invention, as well as its many advantages, may be further understood by the following detailed description and drawings in which:

FIG. 1 illustrates a structure diagram of device for cooling and pressurization of the present invention.

### DETAILED DESCRIPTION OF THE INVENTION

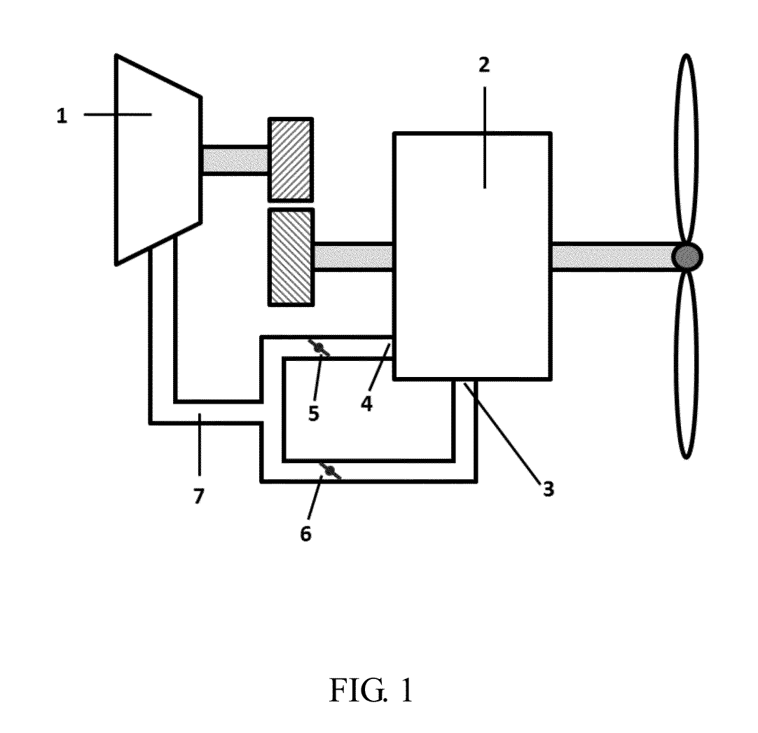

Referring to FIG. 1, which is the structure diagram of a device for cooling and pressurization of the present invention. As shown, the device for cooling and pressurization of the present invention contains: a mechanical charger 1; an outlet tube 7 is used for air flow dispensing, wherein the outlet tube has two sides, and one side is couple to the charger outlet port 1; a first valve 5 is used for controlling air charge quantity of a engine intake tube 3, wherein one terminal of the first valve 5 is coupled to the charger outlet tube 7, and another terminal thereof is coupled to the engine intake tube 3; a second valve 6 is used for controlling air charge quantity of a core cooling tube 4, wherein one terminal of the second valve 6 is coupled to the charger outlet tube 7, and another terminal thereof is coupled to the core cooling tube 4, wherein another sides of the charger outlet tube 7 is respectively coupled the first valve 5 and the second valve 6; and a rotary engine body 2 is coupled to the engine intake tube 3 and the rotor core cooling tube 4 and used for allowing the device to perform the functions of cooling and pressurization.

Preferably, the intake device 1 is a mechanical charger.

Preferably, the first valve 5 is operated by a remote control manner or an automatic control manner.

Preferably, the second valve 6 is operated by a remote control manner or an automatic control manner.

Preferably, the device for cooling and pressurization is connected to the rotary engine body 2 by a parallel manner or a serial manner, or independently mounted on the rotary engine body 2.

Many changes and modifications in the above described embodiment of the invention can, of course, be carried out without departing from the scope thereof. Accordingly, to promote the progress in science and the useful arts, the invention is disclosed and is intended to be limited only by the scope of the appended claims.

What is claimed is:

1. A device for cooling and pressurization, comprising:
a mechanical charger, mounted in a ventilated place;
an outlet tube, for allowing air dispensing, wherein the outlet tube has two sides, and one side is couple to the charger outlet port;
a first valve, for controlling an air charge quantity of a engine intake tube, wherein one terminal of the first valve is coupled to the charger outlet tube, and another terminal thereof is coupled to the engine intake tube;
a second valve, for controlling an air charge quantity of a core cooling tube, wherein one terminal of the second valve is coupled to the charger outlet tube, and another terminal thereof is coupled to the core cooling tube, wherein another sides of the charger outlet tube is respectively coupled the first valve and the second valve; and
a rotary engine body, coupled to the engine intake tube and the core cooling tube, for allowing the device to perform the functions of cooling and pressurization.

2. The device for cooling and pressurization of claim 1, wherein the intake device is a mechanical charger.

3. The device for cooling and pressurization of claim 1, wherein the first valve is operated by a remote control manner or an automatic control manner.

4. The device for cooling and pressurization of claim 1, wherein the second valve is operated by a remote control manner or an automatic control manner.

5. The device for cooling and pressurization of claim 1, wherein the device for cooling and pressurization is connected to the rotary engine by a parallel manner or a serial manner, or independently mounted on the rotary engine.
